(19) United States
(12) Patent Application Publication
(10) Pub. No.: US 2004/0017791 A1
(43) Pub. Date: Jan. 29, 2004

(54) Network controlled call forwarding

(76) Inventors: Pramodkumar Patel, Phoenix, AZ (US); Bernie R. McKibben, Gilbert, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/202,109

(22) Filed: Jul. 23, 2002

(51) Int. Cl. H04B 7/216; H04Q 7/00; H04M 3/42

(52) U.S. Cl. 370/335; 370/328; 379/221.02; 379/207.08

(57) ABSTRACT

If a network (80) incurs blockage or if a called subscriber (200) is unreachable for network blockage or network or inter network errors, the network re-routes the calling subscriber (100). Instead of merely dropping a call or sending a re-order signal to the calling subscriber, the network automatically reroutes (52) the calling subscriber to a voice mail system (95) in the called subscriber's home service network (80).

### BACKGROUND OF THE INVENTION

The present invention pertains to telecommunications networks and more particularly to an arrangement for call forwarding under network control for mobile subscribers.

Traditional call forwarding depends upon action which may initially be activated by a mobile subscriber. In traditional call processing, incoming calls are routed through the network to the home network of the called subscriber. Calls to the particular subscriber subject to call forwarding are typically rerouted by the home network of the called subscriber to an alternate (pre-specified) telephone number (e.g., Voicemail).

Often times networks encounter blockage within or among the networks and cannot appropriately route a calling subscriber to the called subscriber. Such call blockage or network failures may leave the calling subscriber with no indication as to the reason the call did not reach the called subscriber. Typical network responses for the network blockage or error situations are to drop the call and/or send a reorder tone back to the calling subscriber.

Generally, there are four conditions upon which calls may be forwarded. First, a call may be forwarded unconditionally; second, a call may be forwarded upon detection of busy; a call may be forwarded on detection of no reply; and, a call may be forwarded as not reachable. The not reachable basis for call forwarding typically occurs when a mobile subscriber's handset is in the off condition (detached) or for some other reason fails to respond to paging. Accordingly, it would be highly desirable to have an arrangement for call forwarding controlled by the network for network non-connectivity or network failure situation. This situation is one of the most common occurrences being when network signaling resources are not available end to end for subscribers roaming outside their home network.

### BRIEF DESCRIPTION OF THE DRAWING

FIG. 1 is a prior art message flow diagram of an attempted call connection.

FIG. 2 is a block diagram of the network controlled call forwarding in accordance with the present invention.

FIG. 3 is a message flow diagram of a network controlled call forwarding arrangement in accordance with the present invention.

### DESCRIPTION OF THE PREFERRED EMBODIMENT

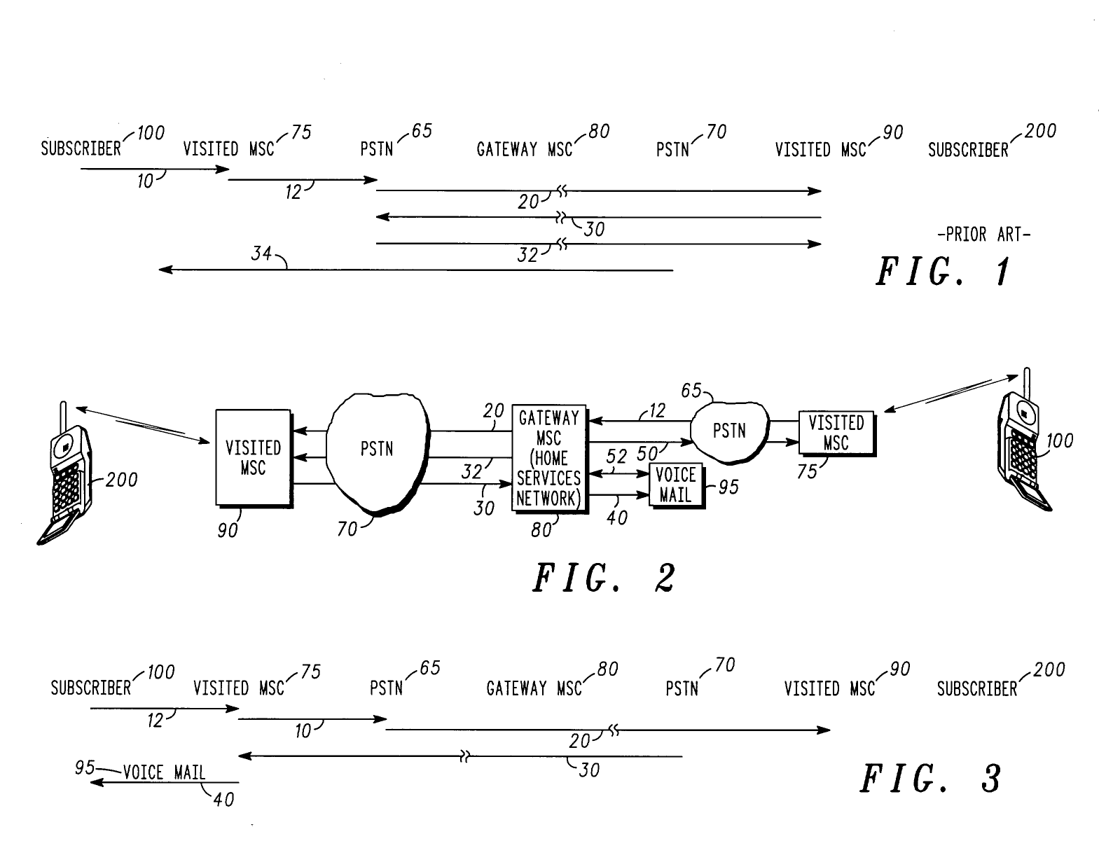

Referring to FIG. 1, a message flow diagram for a signaling system 7 is shown which depicts the prior art arrangement. System signaling 7 connectivity must exist between gateway MSC 80 and visited MSC 90. Gateway MSC80 is located within the home network.

Mobile Subscriber 100 sends a setup message 10 requesting connection to subscriber 200. The setup message 10 is transmitted from subscriber 100 to its Visited MSC 75. The Visited MSC 75 produces the initial address message 12 which is transmitted to the PSTN 65 (Public Switch Telephone Network).

PSTN 65 propagates message 12 which is transmitted to gateway MSC 80. The initial address message (IAM) is an out-of-band signaling message which is a part of the ISUP protocol. The ISUP protocol (ISDN User Part) an out-of-band signaling protocol that supports the ISDN interface. The ISUP protocol is used for GSM and UMTS signaling arrangements.

Upon receipt of the Initial Address Message 12 sent from PSTN 65 to gateway MSC 80. The Gateway MSC 80 sends the Send Routing Information message 20 to the visited MSC 90 through PSTN 70. The send routing information message 20 is a GSM/UMTS Mobile Application Part (MAP) message which is sent from the called party's 200 Home Location Register to the visited MSC 90 when routing information is necessary to attempt to call mobile subscriber 200.

As Shown in FIG. 1, this is typically sent through the PSTN 70 where the PSTN represents a network of one or more switches typically that can typically communicate using the ISUP protocol.

Typically the SRI message would connect through to the visited gateway 90 which would respond back to the Gateway MSC 80 via the PSTN 70 with a Mobile Subscriber Routing Number (a MAP Protocol message). Gateway MSC 80 would then sends an initial address message 32 to visited MSC 90 to complete routing to the called subscriber 200.

However, in this situation, due to a lack of end to end ISUP connectivity or some system error or blockage within the PSTN has caused a system error. The PSTN 70 returns back an indication of lack of resources or network blockage, message 30, to the Gateway MSC 80 which in turn passes it on to the calling subscriber 100 via the PSTN 65 and Calling Party's Visited MSC 75. At this point, subscriber 100 may receive reorder tone or some other indication of failure of connection, message 34. However, subscriber 100 is not aware what failure occurred. Further, subscriber 200 may receive no indication that a call attempt to them failed.

Referring to FIG. 2, a modern multi-media data network such as UMTS is shown including the present invention. In such a network the home or services network is separated from the visited network. Subscriber 100 originates a call to called subscriber 200. This may occur through a PSTN 75. In any event, an initial address message 10 is transmitted to the home services network or CSCF (Call Session Control Function) 80. This is typical for a UMTS system. However, similar arrangements will apply to CDMA 2000 as well as mobile IP networks.

As can be seen from FIG. 2, subscriber 200 is in a visited or a proxy network 90. As a result, gateway MCS or home services network 80 will attempt to establish connection to the visited network proxy agent 90 via PSTN 70 and transmit routing information message 20.

The visited network 90 returns an error message 30 to the home services network 80 via the PSTN 70. Error message 30 indicates that the subscriber 200 was not reachable or busy.

As a result of message 30, home services network or gateway MCS 80 diverts or redirects the session or call attempt to a voicemail or messaging system 95 via link 40. Home services network or gateway MSC 80 then establishes link 50 with subscriber 100, through PSTN 75, for example. Then link 50 is coupled through the home network to voicemail 95 through link 52. Subscriber 100 has been notified of a non-reachable condition of subscriber 200 and is instructed to leave a message. The message is then recorded via link 52 on voicemail system 95.

As can be seen from the above explanation, the call was forwarded as a result of the home services network 80 detecting that subscriber 200 was not reachable. As result, subscriber 100 was not returned a reorder tone or simply dropped not knowing why the call to subscriber 200 did not succeed or not have any ability to leave a message.

This invention allows the ability for the home network to forward for messaging or redirect calls or sessions for a lack of communications between home and visited networks.

The above invention pertains equally well to session initiation protocol (SIP) signaling in mobile packet networks. A collection of conditions may trigger the return of error message 30 from the visited network to the home network. This collection of conditions includes: the called party is either busy or has rejected the call; a bad or erroneous response from the serving network (bad gateway); the called party simply does not desire to participate or cannot participate; and the called party's service agent rejects the request because the requested bandwidth or media description is no acceptable.

The present invention provides the following benefits, namely, increased revenue by generating traffic; terminating calls to voicemail, such calls would otherwise be dropped or unconnected for unexplained reasons. This will increase the customer satisfaction of any network.

FIG. 3 is a message flow diagram similar to that of FIG. 1 except that for detection of error message 30 by gateway or home services network 80, the call is diverted to voicemail 95 via message 40.

Although the preferred embodiment of the invention has been illustrated, and that form described in detail, it will be readily apparent to those skilled in the art that various modifications may be made therein without departing from the spirit of the present invention or from the scope of the appended claims.

1. A method for network controlled call forwarding comprising the steps of
initiating by a first subscriber a call through a first network to a second subscriber;
transmitting the call from the first network to a second network;
returning an error message from the second network to the first network; and
forwarding the call from the first subscriber to an alternate destination by the first network.

2. The method for network controlled call forwarding as claimed in claim 1, wherein the step of forwarding the call from the first subscriber includes the step of forwarding the call from the first subscriber to a voicemail system by the first network.

3. The method for network controlled call forwarding as claimed in claim 1, wherein there is further included a step of requesting by the first network that the first subscriber leave a message due to network difficulties.

4. The method for network controlled call forwarding as claimed in claim 3, wherein there if further included a step of coupling the first subscriber to a voicemail system.

5. The method for network controlled call forwarding as claimed in claim 1, wherein there is further included steps of:
using session initiation protocol; and
the first and second networks are mobile internet protocol networks.

6. The method for network controlled call forwarding as claimed in claim 1, wherein there is further included a step of using by the first and second networks signaling system seven protocol.

7. The method for network controlled call forwarding as claimed in claim 1, wherein there is further included a step of using UMTS protocol by the first and second networks.

8. The method for network controlled call forwarding as claimed in claim 1, wherein there is further included a step of using CDMA 2000 protocol by the first and second networks.

9. The method for network controlled call forwarding as claimed in claim 1, wherein the step of returning an error message includes the step of returning the error message by the first and second network for an error in the second network.

10. The method for network controlled call forwarding as claimed in claim 1, wherein the step of returning an error message includes the step of returning the error message by the second network for an error in the second network.

11. The method for network controlled call forwarding as claimed in claim 1, wherein the step of returning the error message includes the step of returning the error message by the second network if the second subscriber is not reachable.

12. A method for network controlled call forwarding comprising the steps of:
placing a call by a first subscriber in a first network to a second subscriber in a second network;
indicating that the second network is unable to connect to the second subscriber; and
forwarding the call from the first subscriber to a voicemail system.

13. The method for network controlled call forwarding as claimed in claim 12, wherein there is further included steps of:
using session initiation protocol; and
the first and second networks are mobile internet protocol networks.

14. The method for network controlled call forwarding as claimed in claim 12, wherein there is further included a step of using by the first and second networks signaling system seven protocol.

15. The method for network controlled call forwarding as claimed in claim 12, wherein there is further included a step of using UMTS protocol by the first and second networks.

16. The method for network controlled call forwarding as claimed in claim 12, wherein there is further included a step of using CDMA 2000 protocol by the first and second networks.

17. A method for network controlled call forwarding comprising the steps of:
placing a call by a first subscriber in a first network to a second subscriber in a second network;
indicating that the second network is unable to connect to the second subscriber; and
responsive to the indicating step, forwarding the call from the first subscriber to a third subscriber.

18. The method for network controlled call forwarding as claimed in claim 17, wherein there is further included a step of using by the first and second networks signaling system seven protocol.

19. The method for network controlled call forwarding as claimed in claim 17, wherein there is further included a step of using UMTS protocol by the first and second networks.

20. The method for network controlled call forwarding as claimed in claim 17, wherein there is further included a step of using CDMA 2000 protocol by the first and second networks.
